(19) United States
(12) Patent Application Publication
(10) Pub. No.: US 2006/0243780 A1
(43) Pub. Date: Nov. 2, 2006

(54) Conductive substrate, motor, vibration motor and metal terminal for electrical contact having gold-copper layer

(75) Inventors: Seoung-Jae Lee, Suwon-si (KR); Bae-Kyun Kim, Seongnam-si (KR); Sang-Gil An, Suwon-si (KR); Kum-Young Ji, Seoul (KR); Young-Tae Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/412,955

(22) Filed: Apr. 28, 2006

(30) Foreign Application Priority Data
May 2, 2005 (KR) 10-2005-0036812

(51) Int. Cl. B23K 1/00; B21D 39/04

(52) U.S. Cl. 228/127

(57) ABSTRACT

The present invention relates to a conductive substrate, motor, vibration motor, and metal terminal for electrical contact having a gold-copper layer which improves electrical conductivity and abrasion resistance and excellent electrical durability. According to a preferred embodiment of the invention, a conductive substrate which comprises a base board, a copper layer formed on least one side of the base board and made of copper or a copper alloy, and a gold-copper layer formed on the copper layer and made of gold and copper alloy.

### CROSS-REFERENCE TO RELATED APPLICATIONS

This application claims the benefit of Korean Patent Application No. 2005-0036812, filed on May, 2, 2005, with the Korea Intellectual Property Office, herein incorporated by reference in its entirety.

### TECHNICAL FIELD

The present invention relates to a conductive substrate, a motor, a vibration motor, and a metal terminal for electrical contact having a gold-copper layer.

### BACKGROUND

Coating layers of conventional conductive substrates or metal terminals for electrical contact comprise a copper layer of copper or a copper alloy, a middle layer formed on the copper layer, and a conductive layer of gold(Au), nickel(Ni), rhodium(Rd), or the like coated on the surface of the middle layer. Among these, gold has been widely used for its excellent conductivity. A small amount of an additive such as cobalt(Co), indium(ln) and the like is added to a plating bath to form a gold layer, so that it improves abrasion resistance and results in formation of a hard gold-coated (over 99 wt. %) layer. Here, it is essential to have the middle layer such a nickel layer to prevent the diffusion through bonds of metals between the gold or hard gold layer and the copper layer.

FIG. 1 is a sectional view of a conductive substrate according to an embodiment of prior art. Referring to FIG. 1, layers of the conductive substrate are prepared by forming a copper layer 120 of copper or a copper alloy on a base board 110 such as polyimide or epoxy resin. In order to form a gold or hard gold layer 130 thereon, is it required to form a nickel layer 140 between the copper layer 120 and the gold or hard gold layer 130.

FIG. 2 is a sectional view of a metal terminal for electrical contact according to an embodiment of prior art. Referring to FIG. 2, in order to form a gold or hard gold layer, which has high hardness and excellent conductivity, on a copper or a copper alloy layer 120 in the formation of the metal terminal for electrical contact, is it essential to form a middle layer 140 to prevent the diffusion through bonds of metals between the copper layer 120 and the gold or hard gold layer 130.

However, even if a small amount of an additive is used to improve abrasion resistance in the gold or hard gold coating, there is a limit to providing enough abrasion resistance. Alternatively, there is a limit to employing the gold or hard gold coating in the manufacturing of conductive substrates or metal terminals for electrical contact which require excellent abrasion resistance.

A thickness of the gold or hard gold layer is conventionally not less than 1.0 μm to maintain durability of the gold or hard gold layer. Increasing the thickness of the layer causes voids of cobalt or the like added as an additive and further generates metal powders for frictions which interferes a current path. As a result, transmitting current can be interfered due to sparks and the electrical durability of the metal terminal for electrical contact becomes deteriorated.

Such factors disturbing the current path significantly vary with amount of additives used and surface morphology. For example, when cobalt is used as an additive, controlling amount of cobalt in the gold or hard gold layer becomes difficult and a middle layer like a nickel layer is essentially required which results in a complicate manufacturing process.

For example, the above-described problems may often occur in motors comprising a conductive substrate and a brush to supply a current supplied from a power to a commutator embedded in a rotor. Segments in the conductive substrate are in contact with the brush to form a current path and frictions between the conductive substrate and the brush are caused due to rotation of the rotor. Therefore, it is highly demanded to have excellent abrasion resistance of the conductive substrate which contacts with the brush inside the motor.

### SUMMARY

The present invention provides a conductive substrate, a motor, a vibration motor, and a metal terminal for electrical contact having a gold-copper layer which not only allows improved electrical conductivity and abrasion resistance but also exhibits excellent electrical durability.

Additional aspects and advantages of the present general inventive concept will be set forth in part in the description which follows and, in part, will be obvious from the description, or may be learned by practice of the general inventive concept.

An aspect of the present invention provides a conductive substrate comprising a base board; a copper layer formed on at least one side of the base board and made of copper or a copper alloy; and a gold-copper layer formed on the copper layer and made of an alloy of gold and copper.

Another aspect of the present invention provides a conductive substrate comprising a base board; a copper layer formed on at least one side of the base board and made of copper or a copper alloy; a middle layer formed on the copper layer and made of at least one chosen from nickel, gold, silver, copper, palladium, rhodium, cadmium, and alloys thereof; and a gold-copper layer formed on the middle layer and made of an alloy of gold and copper. A thickness of the middle layer is not greater than 0.1 μm.

Here, it may be preferable that a content of gold in the gold-copper layer is in the range of 45 to 95 wt. % and a thickness of the gold-copper layer is not less than 0.5 μm. The gold-copper layer may further comprise at least one chosen from silver, zinc, bismuth, thallium, and alloys thereof.

Still another aspect of the present invention provides a motor comprising a conductive substrate and a brush for forming a current path, wherein the conductive substrate comprises a base board; a copper layer formed on at least one side of the base board and made of copper or a copper alloy; and a gold-copper layer formed on the copper layer and made of an alloy of gold and copper.

Still another aspect of the present invention provides a motor comprising a conductive substrate and a brush for forming a current path, wherein the conductive substrate comprises a base board; a copper layer formed on at least one side of the base board and made of copper or a copper alloy; a middle layer formed on the copper layer and made of at least one chosen from nickel, gold, silver, copper, palladium, rhodium, cadmium, and alloys thereof; and a gold-copper layer formed on the middle layer and made of an alloy of gold and copper. A thickness of the middle layer is not greater than 0.1 μm.

Here, it may be preferable that a content of gold in the gold-copper layer is in the range of 45 to 95 wt. % and a thickness of the gold-copper layer is not less than 0.5 μm. The gold-copper layer may further comprise at least one chosen from silver, zinc, bismuth, thallium, and alloys thereof.

Still another aspect of the present invention provides a vibration motor comprising a rotor including a conductive substrate on at least one side and generating eccentric rotation and a brush fixed to at least one end of and in contact with the conductive substrate, wherein the conductive substrate comprises a base board; a copper layer formed on at least one side of the base board and made of copper or a copper alloy; and a gold-copper layer formed on the copper layer and made of an alloy of gold and copper.

Still another aspect of the present invention provides a vibration motor comprising a rotor including a conductive substrate on at least one side and generating eccentric rotation and a brush fixed to at least one end of and in contact with the conductive substrate, wherein the conductive substrate comprises a base board; a copper layer formed on at least one side of the base board and made of copper or a copper alloy; a middle layer formed on the copper layer and made of at least one selected chosen from nickel, gold, silver, copper, palladium, rhodium, cadmium, and alloys thereof; and a gold-copper layer formed on the middle layer and made of an alloy of gold and copper. A thickness of the middle layer is not greater than 0.1 μm.

Here, it may be preferable that a content of gold in the gold-copper layer is in the range of 45 to 95 wt. % and a thickness of the gold-copper layer is not less than 0.5 μm. The gold-copper layer may further comprise at least one chosen from silver, zinc, bismuth, thallium, and alloys thereof.

Still another aspect of the present invention provides a metal terminal for electrical contact comprising a copper layer made of copper or a copper alloy; and a gold-copper layer formed on the copper layer and made of an alloy of gold and copper.

Still another aspect of the present invention provides a metal terminal for electrical contact comprising a copper layer made of copper or a copper alloy; a middle layer formed on the copper layer and made of at least one chosen from nickel, gold, silver, copper, palladium, rhodium, cadmium, and alloys thereof; and a gold-copper layer formed on the middle layer and made of an alloy of gold and copper. A thickness of the middle layer is not greater than 0.1 μm.

Here, it may be preferable that a content of gold in the gold-copper layer is in the range of 45 to 95 wt. % and a thickness of the gold-copper layer is not less than 0.5 μm. The gold-copper layer may further comprise at least one chosen from silver, zinc, bismuth, thallium, and alloys thereof.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of a conductive substrate according to an embodiment of prior art.

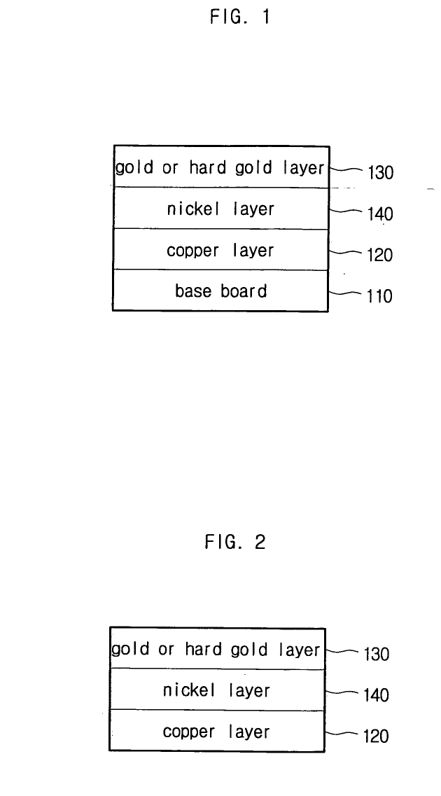

FIG. 2 is a sectional view of a metal terminal for electrical contact according to an embodiment of prior art.

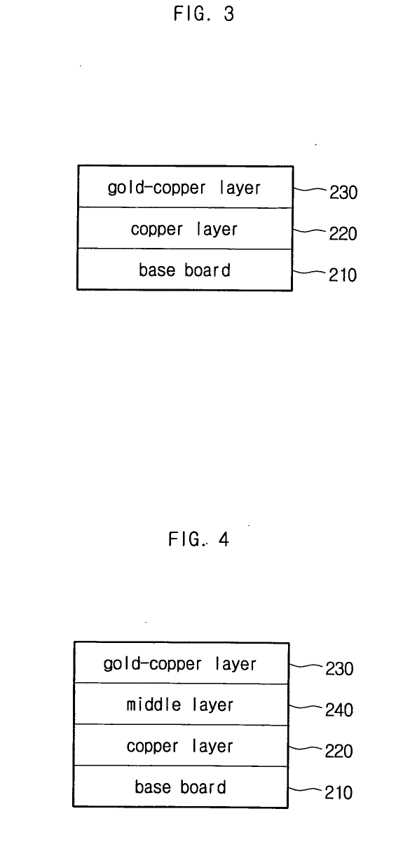

FIGS. 3 to 5 are sectional views of a conductive substrate according to preferred embodiments of the invention.

FIGS. 6 to 8 are sectional views of a metal terminal for electrical contact according to preferred embodiments of the invention.

FIGS. 9 to 11 are SEM pictures illustrating layers of a conductive substrate of preferred embodiments of the invention.

FIG. 12 is a schematic view of a vibration motor according to a preferred embodiment of the invention.

FIG. 13 is a drawing illustrating a conductive substrate included in a vibration motor according to a preferred embodiment of the invention.

### DETAILED DESCRIPTION

Hereinafter, embodiments of the invention will be described in detail with reference to the accompanying drawings. Embodiments of the invention are divided into layers included in a conductive substrate and layers included in a metal terminal for electrical contact. Both layers included in a conductive substrate and layers included in a metal terminal for electrical contact are further divided into two types, respectively. One type is that a gold-copper layer is formed directly on the copper layer and the other type is that there is a middle layer between the gold-copper layer and the copper layer. Here a thickness of the middle layer is not greater than 0.1 μm. Also, embodiments of the invention will describe a motor such as a vibration motor comprising the conductive substrate having such layers.

A conductive substrate of the present invention may be applied in various PCBs such as single sided PCBs, both sided PCBs, multi-layered PCBs, flexible PCBs, rigid PCBs, rigid-flex PCBs, and the like, mounting substrates for semiconductor, low-temperature co-fired ceramics (LTCC), multilayered ceramics (MLC), etc. If a board can include a layer, it may be applied and thus not limited. A motor, which has contact between a conductive substrate and a brush, may be a preferred application example. For example, there is a PCB which performs rectifying action of a vibration motor in vibration electronic components which are mounted in a portable terminal such as mobile phone and vibrate when receiving calls. There are further examples for supplying power or transmitting/receiving signals from or to another device or another board in PCBs, mounting substrates for semiconductor, LTCC, etc. Both sided PCBs having via holes include a copper layer made of copper or a copper alloy and according to the present invention, a gold-copper layer may be formed on such a copper layer having via holes. However, the layer of the present invention is not limited to only this substrate but suitable for any conductive substrate requiring excellent electrical conductivity and abrasion resistance against friction and wear.

Application examples of the metal terminal for electrical contact having the layer of the present invention include plated terminals, cathode and anode terminals of secondary batteries, terminals to receive power supply from an external device, and internal•external metal terminals for transmitting/receiving signals from or to an external device or another device. However, the application of such metal terminals of the present invention is not limited but suitable for any metal terminal requiring excellent electrical conductivity and abrasion resistance against friction and wear.

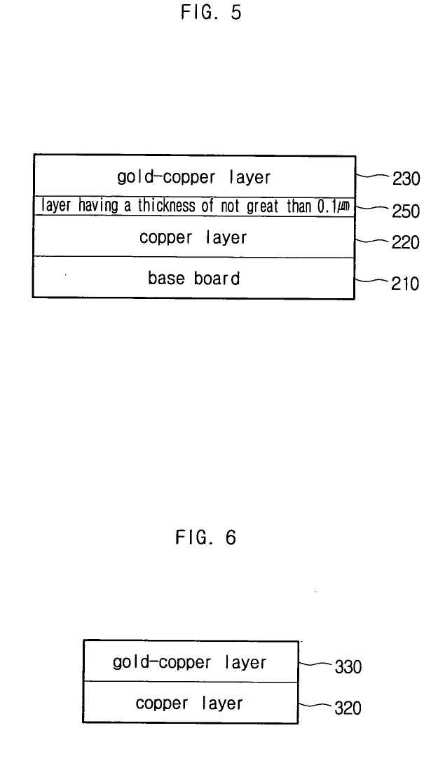

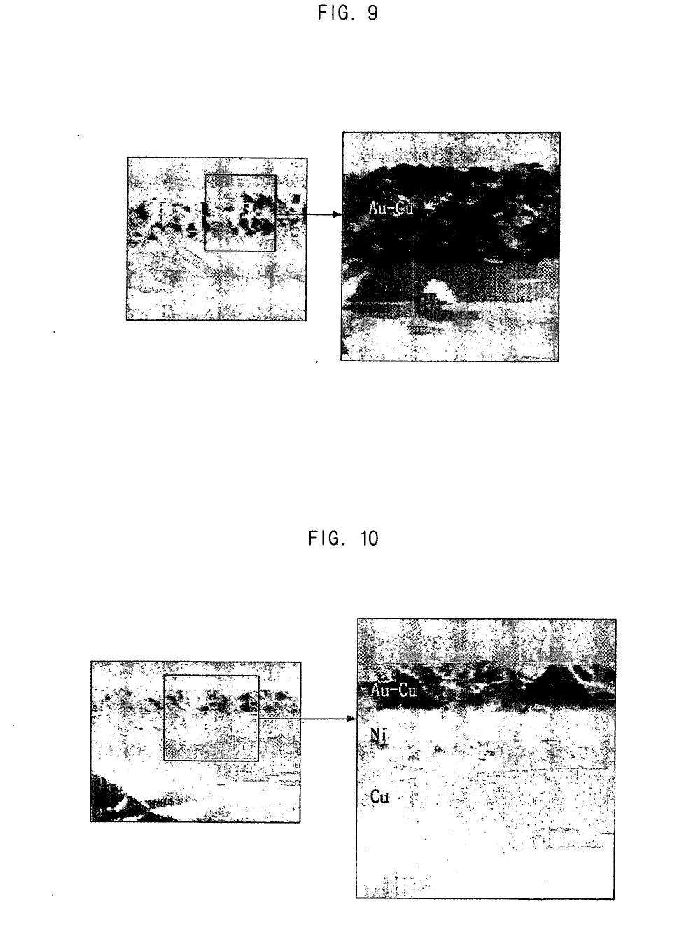

FIG. 3 is a sectional view of a conductive substrate according to a preferred embodiment of the present invention. Referring to FIG. 3, a copper layer 220 made of copper or a copper alloy is formed on a base board 210 and a gold-copper layer 230 is then formed on the copper layer 220. FIG. 9 is a SEM picture illustrating the conductive substrate having such layered structure which shows layers of the copper layer and gold-copper layer, not the base board.

FIG. 4 is a sectional view of a conductive substrate according to another preferred embodiment of the invention. Referring to FIG. 4, a copper layer 220 made of copper or a copper alloy is formed on a base board 210, a middle layer 240 is formed on the copper layer 220, and a gold-copper layer 230 is then formed on the middle layer 240. FIG. 10 is a SEM picture illustrating the conductive substrate having the middle layer which shows layers of the copper, the nickel as the middle layer, and the gold-copper, not the base board.

FIG. 5 is a sectional view of a conductive substrate according to further another preferred embodiment of the invention. Referring to FIG. 5, a copper layer 220 made of copper or a copper alloy is formed on a base board 210, a layer 250 having a thickness of not greater than 0.1 μm is formed on the copper layer 220, and gold-copper layer 230 is then formed on the layer 250 having a thickness of not greater than 0.1 μm. FIG. 11 is a SEM picture illustrating the conductive substrate having the layer having a thickness of not greater than 0.1 μm, which shows layers of the copper, layer having a thickness of not greater than 0.1 μm, and gold-copper, not the base board.

The base board 210 may be any film appropriate for forming a conductive substrate and thus not limited. Example of the base board includes epoxy resins, polyimides, polyesters, etc.

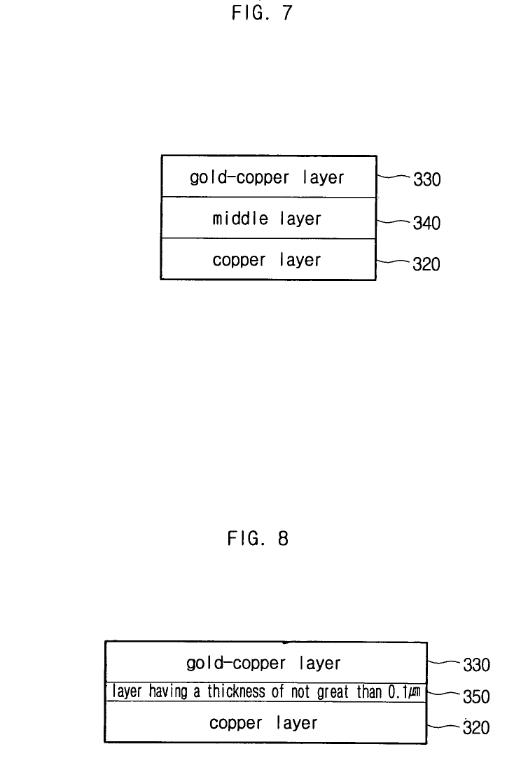

FIG. 6 is a sectional view of a metal terminal for electrical contact according to a preferred embodiment of the invention. Referring to FIG. 6, the metal terminal for electrical contact has a layered structure of a gold-copper layer 330 formed on a copper layer 320 of copper or a copper alloy. FIG. 9 is a SEM picture illustrating such layered structure.

FIG. 7 is a sectional view of a metal terminal for electrical contact according to another preferred embodiment of the invention. Referring to FIG. 7, the metal terminal for electrical contact has a layered structure of a gold-copper layer 330 formed on a middle layer 340 formed on a copper layer 320 of copper or a copper alloy. FIG. 10 is a SEM picture illustrating such layered structure.

FIG. 8 is a sectional view of a metal terminal for electrical contact according to further another preferred embodiment of the invention. Referring to FIG. 8, the metal terminal for electrical contact has a layered structure of a gold-copper layer 330 formed on a layer 350 having a thickness of not greater than 0.1 μm formed on a copper layer 320 of copper or a copper alloy. FIG. 11 is a SEM picture illustrating such layered structure.

The gold-copper layer of the invention exhibits better abrasion resistance and electrical conductivity than conventional gold or hard gold layers, and further lowers a manufacturing cost of conductive substrates and metal terminals for electrical contact since a content of gold in the gold-copper layer is less than that of the conventional gold or hard gold layers. A thickness of the gold-copper layer of the invention is 0.5 to 2 μm. When the thickness is equal to or greater than 0.5 μm, it exhibits desired abrasion resistance, while the conventional gold or hard gold layer should have greater than 1.0 μm of a thickness to obtain abrasion resistance. Therefore, it is not necessary to have a layer having a thickness of greater than 2 μm since the gold-copper layer having a thickness of equal to or less than 2 μm provides enough electrical conductivity and abrasion resistance. But the gold-copper layer mounted in metal terminals for electrical contact may have up to 5 μm of a thickness in order to provide electrical durability and abrasion resistance to be protected from external pressures.

Further, the gold-copper layer has hard metal bonds as an alloy form, so that it eliminates a fear of void of copper like void of cobalt. Since there is no diffusion between the gold-copper layer and the copper layer, it does not necessarily require for forming a middle layer and thus the gold-copper layer may be formed directly on the surface of the copper layer. It may therefore simplify a process of coating on conductive substrates and metal terminals for electrical contact when such direct coating is used.

According to a preferred embodiment of the invention, it may be preferable that 12K to 23K gold is used in the gold-copper layer and a content of gold in the gold-copper layer is in the range of 45 to 95 wt. %, more preferable 70wt %. It may be the most preferable that kind and content of gold is a minimum amount of gold within the range to provide desired electrical conductivity and abrasion resistance in an economical aspect.

The gold-copper layer may optionally include additives. According to a preferred embodiment of the invention, example of the additive include silver(Ag), zinc(Zn), bismuth(Bi), thallium(Tl), and alloys thereof. The additive is added in the gold-copper layer to prevent from decolorization and improve durability and abrasion resistance.

Further, a middle layer may be formed on the copper layer of copper or a copper alloy, followed by forming the gold-copper layer having excellent abrasion resistance thereon. A metal to form the middle layer is chosen from nickel, gold, silver, copper, palladium, rhodium, cadmium, and alloys thereof. For example, when nickel is selected for the middle layer, the middle layer may be formed by the same manner which is used to form a nickel layer to prevent metal diffusion. The middle layer is not necessarily required since there is no fear of metal diffusion in the present invention but may optionally be formed. A thickness of the middle layer is preferably 1 to 5 μm but the thinner thickness is the more preferable since there is no metal diffusion between the copper layer and the gold-copper layer.

The middle layer may be formed by a strike plating method. The strike plating method consists of forming a layer having a thickness of not greater than 0.1 μm on the copper layer within a short period of time and forming the gold-copper layer thereon. According to a preferred embodiment, it is preferable to have a thickness of 0.01 to 0.1 μm, more preferable not greater than 0.08 μm.

The present invention further provides a motor including the conductive substrate described above. For a motor having a brush, particularly a motor having a conductive substrate to form a current path and perform rectifying action and a brush, the conductive substrate in contact with the brush requires excellent abrasion resistance, so that it may be preferable to use the conductive substrate having excellent electrical conductivity and abrasion resistance of the present invention.

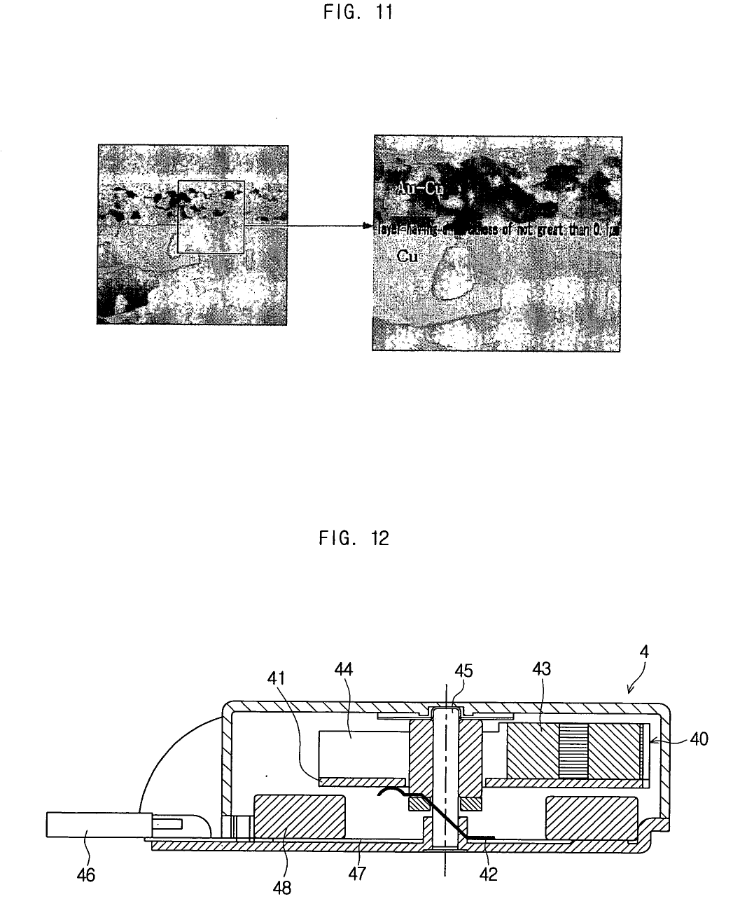

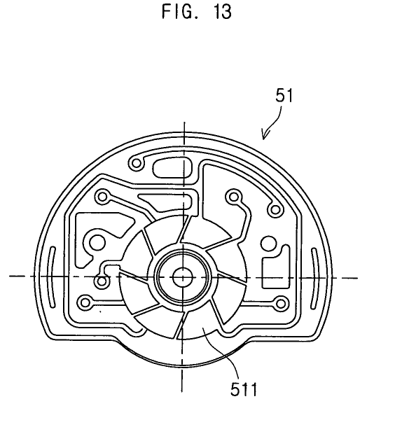

As an example of the motor, FIG. 12 represents a schematic view of a vibration motor according to a preferred embodiment of the invention and FIG. 13 represents a conductive substrate mounted in a vibration motor according to a preferred embodiment of the invention. Referring to FIGS. 12 and 13, when an external power (not shown) is supplied to a lead wire 46 or a flexible board 47, a brush 42 and a conductive substrate 41 which form a current path are required to transmit the current to a coil 43 of a rotor 40. The brush 42 of which at least one end is fixed is in contact with the conductive substrate 41 and transmits the supplied current to the conductive substrate 41. The conductive substrate 41 mounted on one side of the rotor 40 transmits the received current to the coil 43 and the rotor 40 rotates due to interaction with a magnet 48. Here, when the rotor is eccentric, it generates vibration. Here, the contact portion between the brush 42 and the conductive substrate 41, particularly segments 511 inside the conductive substrate 41, suffers abrasions. The vibration motor further comprises a resin 44 made of insulating materials to support the coil 43 or an eccentric poise to maximize eccentric rotation and a shaft 45 to support the rotor 40.

Example of the motor of the present invention is not limited to the above-described vibration motor but may include any motor having a brush and a conductive substrate to form current paths.

### Embodiments

Hereinafter, plating conditions and testing according to preferred embodiments of the present invention will be described in more detail.

### EXAMPLE

(1) Plating Condition to Form a Middle Layer

temperature: 30 to 60° C.
pH: 2 to 6
KM(CN)₂: 0.1 to 1.0 g/L (wherein M is at least one chosen from gold(Au), silver(Ag), nickel(Ni), copper(Cu), palladium(Pd), rhodium(Rh), cadmium(Cd), and alloys thereof)
makeup: 50 to 100 ml/L of potassium phosphate, zinc acetate, nickel sulfamate, or citric acid
current density: 5.0 to 15 A/dm²
   (2) Condition to Form a Nickel Layer as a Middle Layer (Watt's Nickel Plating Bath)
temperature: 40 to 50° C.
pH: 4.0 to 4.5
NiSO₄.H₂O: 280 g/L
NiCI₂.H₂O: 50 g/L
H₃BO₄: 45 g/L

Nickel plating may be performed according to a conventional technology and nickel sulfamate plating instead of watt's nickel plating may be also performed.

(3) Plating Condition to Form a Layer Having a Thickness of Not Greater than 0.1μm (Strike Plating)

temperature: 30 to 60° C.
pH: 2 to 6
KM(CN)₂: 0.1 to 1.0 g/L (wherein M is at least one chosen from gold(Au), silver(Ag), nickel(Ni), copper(Cu), palladium(Pd), rhodium(Rh), cadmium(Cd), and alloys thereof)
a mixture of nickel sulfate and hydrochloric acid: 20 to 60 g/L
current density: 5.0 to 15 A/dm₂

A layer having a thickness of not greater than 0.1 μm is formed by the strike plating method.

(4) Plating Condition to Form a Gold-Copper Layer

temperature: 50 to 90° C.
pH: 8 to 9
KAu(CN)₂: 2 to 16 g/L
KCu(CN)₂: 0.2 to 10 g/L
makeup: 50 to 100 ml/L of potassium phosphate, zinc acetate, nickel sulfamate, or citric acid
current density: 0.1 to 1.5 A/dm²
0.05 to 1.0 g/L of KX(CN)₂ may be optionally added (wherein X is silver(Ag), zinc(Zn), bismuth(Bi), or thallium(Tl))

A gold-copper layer is formed according to the plating condition and hardness thereof is determined and summarized in Table 1.

### COMPARATIVE EXAMPLE

(1) Hard Gold Plating Condition (Use of Cobalt as an Additive)

temperature: 50 to 90° C.
pH: 8 to 9
KAu(CN)₂: 4.0 g/L
KCo(CN)₃: 2.0 g/L
coconut fatty acids diethanolamide as an organic acid: 65 to 85 g/L
current density: 0.1 to 1.5 A/d m²
   (2) Nickel Plating Condition (Watt's Nickel Plating)
temperature: 40 to 50° C.
pH: 4.0to 4.5
NiSO₄.H₂O: 280 g/L
NiCI₂.H₂O: 50 g/L
H₃BO₄: 45 g/L

Nickel plating may be performed according to a conventional technology and nickel sulfamate plating instead of watt's nickel plating may be also performed.

A hard gold layer is formed according to the hard gold plating condition and hardness thereof is determined and summarized in Table 1.

TABLE 1

| | Gold-copper layer of | Hard gold layer of |
|---|---|---|
| Test (unit) | example | comparative example |
| Microscratch (N) | 1.46 ± 0.1 | 1.14 ± 0.1 |
| Nano indenter (Gpa) | 1.90 ± 0.2 | 1.56 ± 0.2 |
| Microhardness (Hv) | 95.9 ± 5 | 69.9 ± 5 |
| Abrasion depth (μm) | 0.5 | 1.5 ± 0.5 |

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

According to the present invention as described above, the conductive substrate and the metal terminal for electrical contact provide excellent abrasion resistance, electrical conductivity, and high electrical durability. The motor such as vibration motor including such conductive substrate also has excellent durability against mechanical abrasion and thus allows a long lifetime.

Particularly, gold and copper form stable bonds as an alloy and thus it is not required to add cobalt as an additive to improve abrasion resistance. Therefore, metal powders are not formed because of no frictions caused by void of cobalt and any problem of current transmission becomes lowered. A content of gold is low, so that the layer may be formed economically and a manufacturing process may be simplified since it does not require for forming a middle layer.

Since the electrical conductivity is dependent on not additives but physical properties of the gold-copper layer, use of the gold-copper layer of the present invention may provide excellent electrical conductivity. The gold-copper layer further enhances hardness and strength, so that it provides excellent abrasion resistance against electrical contacts or frictions from external pressures.

What is claimed is:

1. A conductive substrate comprising:
a base board;
a copper layer formed on at least one side of the base board and made of copper or a copper alloy; and
a gold-copper layer formed on the copper layer and made of an alloy of gold and copper.

2. A conductive substrate comprising:
a base board;
a copper layer formed on at least one side of the base board and made of copper or a copper alloy;
a middle layer formed on the copper layer and made of at least one selected from the group consisting of nickel, gold, silver, copper, palladium, rhodium, cadmium, and alloys thereof; and
a gold-copper layer formed on the middle layer and made of an alloy of gold and copper.

3. The conductive layer of claim 2, wherein a thickness of the middle layer is not greater than 0.1 μm.

4. The conductive layer of claim 1, wherein a content of gold in the gold-copper layer is in the range of from 45 to 95 wt %.

5. The conductive layer of claim 2, wherein a content of gold in the gold-copper layer is in the range of from 45 to 95 wt %.

6. The conductive layer of claim 1, wherein a thickness of the gold-copper layer is not less than 0.5 μm.

7. The conductive layer of claim 2, wherein a thickness of the gold-copper layer is not less than 0.5 μm.

8. The conductive layer of claim 1, wherein the gold-copper layer further comprises at least one selected from the group consisting of silver, zinc, bismuth, thallium, and alloys thereof.

9. The conductive layer of claim 2, wherein the gold-copper layer further comprises at least one selected from the group consisting of silver, zinc, bismuth, thallium, and alloys thereof.

10. A motor comprising a conductive substrate and a brush for forming a current path, wherein the conductive substrate comprises:
a base board;
a copper layer formed on at least one side of the base board and made of copper or a copper alloy; and
a gold-copper layer formed on the copper layer and made of an alloy of gold and copper.

11. A motor comprising a conductive substrate and a brush for forming a current path, wherein the conductive substrate comprises:
a base board;
a copper layer formed on at least one side of the base board and made of copper or a copper alloy;
a middle layer formed on the copper layer and made of at least one selected from the group consisting of nickel, gold, silver, copper, palladium, rhodium, cadmium, and alloys thereof; and
a gold-copper layer formed on the middle layer and made of an alloy of gold and copper.

12. The motor of claim 11, wherein a thickness of the middle layer is not greater than 0.1 μm.

13. The motor of claim 10, wherein a content of gold in the gold-copper layer is in the range of from 45 to 95 wt %.

14. The motor of claim 11, wherein a content of gold in the gold-copper layer is in the range of from 45 to 95 wt. %.

15. The motor of claim 10, wherein a thickness of the gold-copper layer is not less than 0.5 μm.

16. The motor of claim 11, wherein a thickness of the gold-copper layer is not less than 0.5 μm.

17. The motor of claim 10, wherein the gold-copper layer further comprises at least one selected from the group consisting of silver, zinc, bismuth, thallium, and alloys thereof.

18. The motor of claim 11, wherein the gold-copper layer further comprises at least one selected from the group consisting of silver, zinc, bismuth, thallium, and alloys thereof.

19. A vibration motor comprising a rotor including a conductive substrate on at least one side and generating eccentric rotation and a brush of which at least one end is fixed and in contact with the conductive substrate, wherein the conductive substrate comprises:
a base board;
a copper layer formed on at least one side of the base board and made of copper or a copper alloy; and
a gold-copper layer formed on the copper layer and made of an alloy of gold and copper.

20. A vibration motor comprising rotor including a conductive substrate on at least one side and generating eccentric rotation and a brush of which at least one end is fixed and in contact with the conductive substrate, wherein the conductive substrate comprises:
a base board;
a copper layer formed on at least one side of the base board and made of copper or a copper alloy;
a middle layer formed on the copper layer and made of at least one selected from the group consisting of nickel, gold, silver, copper, palladium, rhodium, cadmium, and an alloy thereof; and
a gold-copper layer formed on the middle layer and made of an alloy of gold and copper.

21. The vibration motor of claim 20, wherein a thickness of the middle layer is not greater than 0.1 μm.

22. The vibration motor of claim 19, wherein a content of gold in the gold-copper layer is in the range of from 45 to 95 wt %.

23. The motor of claim 20, wherein a content of gold in the gold-copper layer is in the range of from 45 to 95 wt %.

24. The motor of claim 19, wherein a thickness of the gold-copper layer is not less than 0.5 μm.

25. The motor of claim 20, wherein a thickness of the gold-copper layer is not less than 0.5 μm.

26. The motor of claim 19, wherein the gold-copper layer further comprises at least one selected from the group consisting of silver, zinc, bismuth, thallium, and alloys thereof.

27. The motor of claim 20, wherein the gold-copper layer further comprises at least one selected from the group consisting of silver, zinc, bismuth, thallium, and alloys thereof.

28. A metal terminal for electrical contact comprising:
a copper layer made of copper or a copper alloy; and
a gold-copper layer formed on the copper layer and made of an alloy of gold and copper.

29. A metal terminal for electrical contact comprising:
a copper layer made of copper or a copper alloy;
a middle layer formed on the copper layer and made of at least one selected from the group consisting of nickel, gold, silver, copper, palladium, rhodium, cadmium, and alloys thereof; and
a gold-copper layer formed on the middle layer and made of an alloy of gold and copper.

30. The metal terminal of claim 29, wherein a thickness of the middle layer is not greater than 0.1 μm.

31. The metal terminal of claim 28, wherein a content of gold in the gold-copper layer is in the range of from 45 to 95 wt %.

32. The metal terminal of claim 29, wherein a content of gold in the gold-copper layer is in the range of from 45 to 95 wt %.

33. The metal terminal of claim 28, wherein a thickness of the gold-copper layer is not less than 0.5 μm.

34. The metal terminal of claim 29, wherein a thickness of the gold-copper layer is not less than 0.5 μm.

35. The metal terminal of claim 28, wherein the gold-copper layer further comprises at least one selected from the group consisting of silver, zinc, bismuth, thallium, and alloys thereof.

36. The metal terminal of claim 29, wherein the gold-copper layer further comprises at least one selected from the group consisting of silver, zinc, bismuth, thallium, and alloys thereof.
